(19) United States
(12) Patent Application Publication
(10) Pub. No.: US 2002/0097485 A1
(43) Pub. Date: Jul. 25, 2002

(54) Confocal microscope

(75) Inventor: Mikio Aoshima, Tokyo (JP)

Correspondence Address: STAAS & HALSEY LLP, 700 11TH STREET, NW, SUITE 500, WASHINGTON, DC, 20001, US

(73) Assignee: Nikon Corporation, Tokyo (JP)

(21) Appl. No.: 09/911,510

(22) Filed: Jul. 25, 2001

(30) Foreign Application Priority Data
Jan. 23, 2001 (JP) 2001-014061

(51) Int. Cl. G02B 21/00; G02B 21/06; G02B 27/14

(52) U.S. Cl. 359/368; 359/385; 359/634

(57) ABSTRACT

A confocal microscope includes a light source, an objective lens, a scanning unit for scanning a laser beam emitted from the light source, and for illuminating a specimen via the objective lens, a beam splitter for reflecting the laser beam coming from the light source going toward the objective lens, and for transmitting a detecting light reflected from the specimen, a reflection mirror for reflecting the detecting light transmitted through the beam splitter, an optical element on which the beam splitter and the reflection mirror are attached, a collector lens for converging the detecting light reflected by the reflection mirror, an aperture set in a position optically conjugate with the focal plane of the objective lens, and a detector for detecting the detecting light converged by the collector lens and passed through the aperture.

### INCORPORATION BY REFERENCE

The disclosure of the following priority application is herein incorporated by reference:

Japanese Patent Application No. 2001-014061 filed Jan. 23, 2001.

### BACKGROUND OF THE INVENTION

1. Field of the Invention

The present invention relates to a confocal microscope and, in particular, relates to a confocal fluorescence microscope detecting fluorescence from a specimen.

2. Related Background Art

In a common confocal microscope, a light source, a focal plane of an objective lens, and a confocal aperture are set to be optically conjugate with each other relative to the objective lens and a collector lens. Among light from the specimen, only the light focused on the confocal point by the collector lens can reach a detector to form a light intensity data, so that a clear, two-dimensional image of the specimen can be obtained avoiding the light from anywhere other than the focal plane of the objective lens.

Accordingly, the confocal microscope is used widely in the field of biological microscope as well as industrial microscope because of its superior characteristics such as resolution, and the like relative to other microscopes. In the field of biology in particular, when the confocal microscope is constructed as a fluorescence microscope detecting fluorescence from the specimen, the characteristics of the confocal optical system can be fully exhibited.

A confocal fluorescence microscope according to prior art will be explained below with reference to FIG. 5.

As shown in FIG. 5, a confocal fluorescence microscope according to prior art is composed of a laser unit 10 as a light source, a dichroic mirror 16a as a beam splitter, a scanning unit 22, a scanning optical system 24 consisting of a plurality of lenses and the like, an objective lens 26, a reflection mirror 18a, a collector lens 34, an aperture plate 36 set to the optically conjugate position with the focal plane of the objective lens 26, and a photoelectric detector 38. Among them, the laser unit 10, the scanning unit 22, and the objective lens 26 compose a conventional scanning microscope. The other elements such as the dichroic mirror 16a, the reflection mirror 18a, the collector lens 34, the aperture plate 36, and the like are specific components of the confocal microscope.

The confocal fluorescence microscope functions as explained below.

A laser beam 12 for excitation emitted from the laser unit 10 as a light source is reflected by the dichroic mirror 16a, and is incident to the scanning unit 22. Then, the laser beam 12 scanned by the scanning unit 22 is passed through the scanning optical system 24 consisting of a plurality of lenses and the like, and is incident to the objective lens 26. A specimen 30 placed on a stage 28 is illuminated and scanned two-dimensionally by the laser beam 12 in the state of converged by the objective lens 26.

In accordance with a fluorescence reagent used in response to various purposes of observation, fluorescence 32 with a specific wavelength is emitted from the specimen 30 illuminated and scanned two-dimensionally by the converged laser beam 12. The fluorescence 32 emitted from the specimen 30 as a detecting light passes along the optical path where the laser beam 12 has passed in the opposite direction, and reaches the dichroic mirror 16a via the objective lens 26, the scanning optical system 24, and the scanning unit 22.

The fluorescence 32 with a specific wavelength reached the dichroic mirror 16a transmits the dichroic mirror 16a without being reflected due to the characteristic of the dichroic mirror that selectively reflects or transmits a specific wavelength, is reflected by the reflection mirror 18a, and is incident on the collector lens 34. Then, the fluorescence 32 converged by the collector lens 34 focuses on the small aperture (confocal aperture) formed on the aperture plate 36 placed on the position optically conjugate with the focal plane of the objective lens 26.

Only the fluorescence 32 converged and focused on the aperture of the aperture plate 36 is passed therethrough and reaches the photoelectric detector 38. Then, light intensity data of the fluorescence 32 photoelectrically transformed by the photoelectric detector 38 is converted into digital signal by an A/D converter 40. The digital signal is input into a CPU 42 with a sampling clock synchronized with the scanning of the scanning unit 22. Two-dimensional image of the specimen 30 optically sliced on the focal plane of the objective lens 26 is formed by the CPU 42, and is properly shown on a display (not shown).

Incidentally, in the aforementioned conventional confocal fluorescence microscope, the diameter of the aperture of the aperture plate 36 is generally from several tens to over hundred μm because the diameter of the Airy's disk of the fluorescence 32 converged by the collector lens 34 is usually used as a criterion. Accordingly, the position of the aperture of the aperture plate 36 must be made and adjusted precisely. Therefore, it is desirable for the confocal fluorescence microscope once assembled and adjusted the position of the aperture of the aperture plate 36 not to cause a change in the positional relation in related optical paths.

On the other hand, it is desirable for those who use the confocal fluorescence microscope that conditions such as the wavelength of the laser beam 12 for excitation irradiating the specimen 30, the fluorescence reagent applied to the specimen 30, the wavelength of the fluorescence 32 (detecting fluorescence wavelength) emanated from the specimen 30 in accordance with the fluorescence reagent, and the like can be varied depending on purposes of the observation. When the condition is to be changed, it will happen that the dichroic mirror 16a assembled previously must be changed into another dichroic mirror 16a having different characteristics. Then, it becomes a problem to keep the angle of the reflecting surface of the dichroic mirror 16a relative to the laser beam 12 in case where the dichroic mirror is replaced or changed.

As an example, it is assumed that the diameter of the light flux of the fluorescence 32 returning from the specimen 30 to the scanning unit 22, defined by the diameter of the pupil of the objective lens 26 and the scanning optical system 24 is 2 mm. In this case, when the focal length f of the collector lens 34 is 100 mm, the diameter of the Airy's disk converged to the aperture of the aperture plate 36 becomes 0.05 mm by calculation, so that the diameter of the aperture for the confocal fluorescence detection has about the same size.

Assuming that the angle of the reflecting surface of the dichroic mirror 16a relative to the laser beam 12 varies an angle δ=0.5′ on changing the dichroic mirror 16a, the laser beam 12 reflected from the changed dichroic mirror 16a is to be incident to the scanning unit 22 in a state varied twice the angle, that is 2δ=1.0′. After the laser beam 12 has scanned the specimen 30 two-dimensionally via the scanning optical system 24 and the objective lens 26, the fluorescence 32 returning from the specimen 30 via the objective lens 26, the scanning optical system 24, and the scanning unit 22 is incident to the dichroic mirror 16a in the state varied the same angle, that is 2δ=1.0′, by means of the principle of confocal microscope. The fluorescence 32 in the state varied by the angle 2δ=1.0′ passes through the dichroic mirror 16a and is incident to the collector lens 34 after reflected by the reflection mirror 18a. Assuming that the collector lens has the focal length of f=100 mm, the fluorescence 32 is converged by the collector lens 34 to a position deviated from the aperture of the aperture plate 36 by the amount of Δx: where

Δx−f×tan(2δ)−0.029 mm.

This means that the fluorescence 32 is converged to the position deviated from the aperture of the aperture plate 36 by more amount than the radius of the aperture.

Accordingly, when only the fluorescence 32 converged and formed image on the aperture of the aperture plate 36 is converted photoelectrically by the photoelectric detector 38 to obtain light intensity data, it causes quite large detection loss, so that it may happen that the clear two-dimensional image of the specimen 30 cannot be obtained.

Therefore, on replacing the dichroic mirror 16a for another, the greatest care must be paid for installing in order that the angle of the reflecting surface of the dichroic mirror 16a relative to the laser beam 12 is precisely coincide with the designed angle, or an extremely precise adjustment after the installation must be required.

However, such an installation or an adjustment is quite difficult and time-consuming job for the ordinary user of the confocal fluorescence microscope. Accordingly, it has been the problem to be solved that the ordinary user of the confocal fluorescence microscope can easily install the dichroic mirror 16a and the reflection mirror 18a.

### SUMMARY OF THE INVENTION

The present invention is made in view of the aforementioned problems and has an object to provide a confocal microscope capable of obtaining a clear image of a specimen by allowing a user to install a beam splitter and a reflection mirror easily.

According to one aspect of the present invention, a confocal microscope includes a light source, an objective lens, a scanning unit for scanning a laser beam emitted from the light source, and for illuminating a specimen via the objective lens, a beam splitter for reflecting the laser beam coming from the light source going toward the objective lens, and for transmitting a detecting light reflected from the specimen, a reflection mirror for reflecting the detecting light transmitted through the beam splitter, an optical element on which the beam splitter and the reflection mirror are attached, a collector lens for converging the detecting light reflected by the reflection mirror, an aperture set in a position optically conjugate with the focal plane of the objective lens, and a detector for detecting the detecting light converged by the collector lens and passed through the aperture.

In one preferred embodiment of the present invention, the optical element is removably attached.

In one preferred embodiment of the present invention, the optical element is made of a transparent optical material surrounded by a plurality of planes. A plane on which the laser beam from the light source and the detecting light from the specimen are incident has characteristics of a beam splitter. A plane on which the detecting light from the specimen entered into the optical element reaches has characteristics of a reflection mirror.

In one preferred embodiment of the present invention, the plane on which the laser beam from the light source and the detecting light from the specimen are incident is divided into a plurality of areas each having different beam splitter characteristics. The optical element is slidable such that the laser beam from the light source and the detecting light from the specimen are incident to a predetermined area among the plurality of areas.

In one preferred embodiment of the present invention, a plane on which the detecting light from the specimen entered into the optical element goes out has characteristics of an anti-reflection film.

In one preferred embodiment of the present invention, the beam splitter is a dichroic mirror.

### BRIEF DESCRIPTION OF THE DRAWINGS

FIG. 1 is a diagram showing the structure of a confocal fluorescence microscope according to a first embodiment of the present invention;

FIGS. 2A and 2B are diagrams explaining light paths of a laser beam and fluorescence as a detecting light when an optical element having characteristics of a dichroic mirror as well as a reflection mirror of the confocal fluorescence microscope shown in FIG. 1 is replaced;

FIG. 3 is a diagram showing the sectional view of an optical element having characteristics of a dichroic mirror as well as a reflection mirror of a confocal fluorescence microscope according to a second embodiment of the present invention;

FIGS. 4A and 4B are diagrams showing the sectional view and the front elevation view, respectively, of an optical element having characteristics of a dichroic mirror as well as a reflection mirror of a confocal fluorescence microscope according to a third embodiment of the present invention; and

FIG. 5 is a diagram showing the structure of a conventional confocal fluorescence microscope.

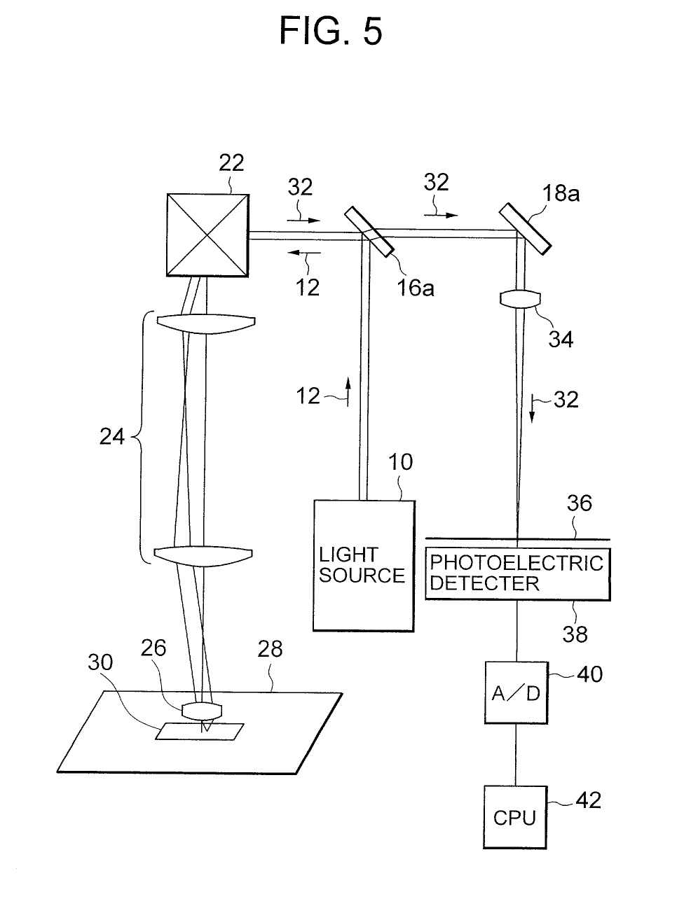

### DESCRIPTION OF THE PREFERRED EMBODIMENTS

Embodiments of the present invention will be explained below with reference to the accompanying drawings.

<First Embodiment>

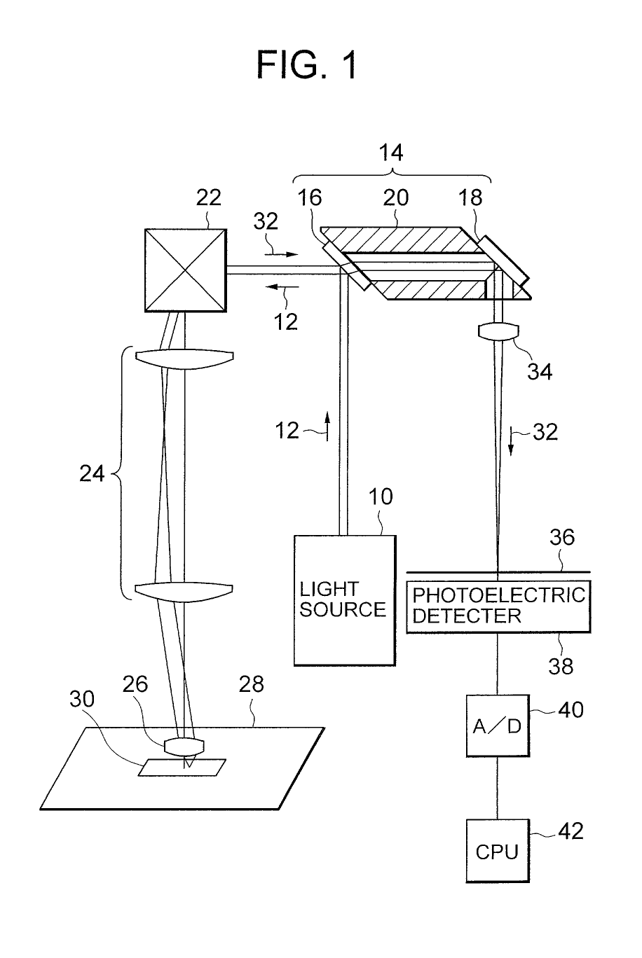

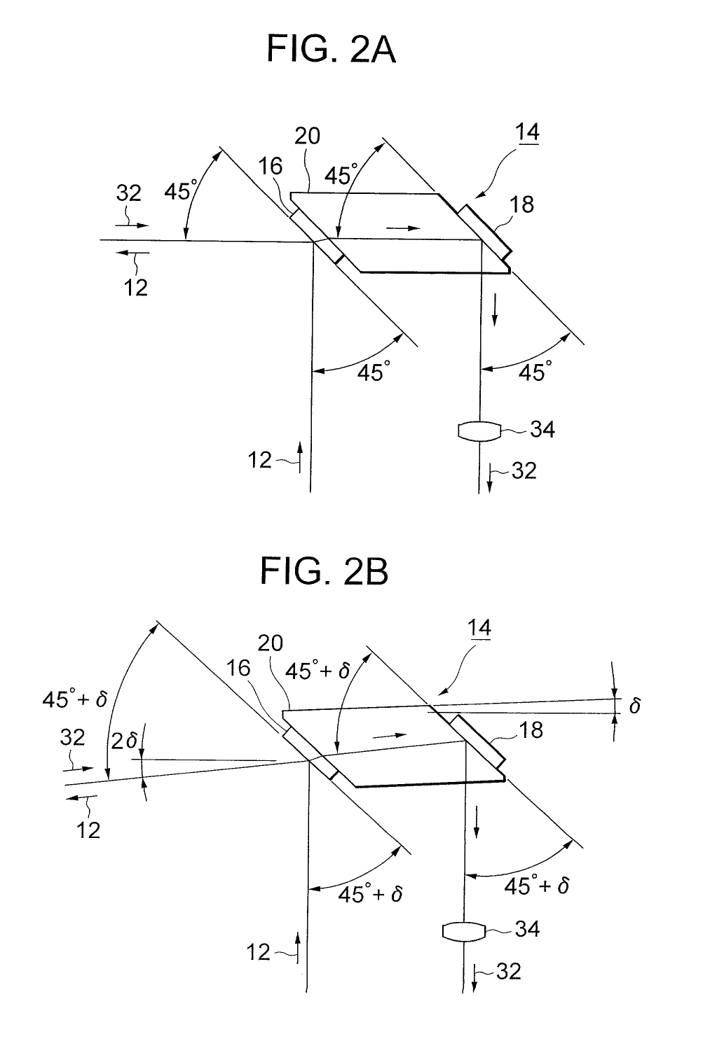

FIG. 1 is a diagram showing the structure of a confocal fluorescence microscope according to a first embodiment of the present invention. FIGS. 2A and 2B are diagrams explaining light paths of a laser beam and fluorescence as a detecting light when an optical element having characteristics of a dichroic mirror as well as a reflection mirror of the confocal fluorescence microscope shown in FIG. 1 is replaced.

As shown in FIG. 1, in the confocal fluorescence microscope according to the first embodiment, a laser beam 12 for excitation emitted from a laser unit 10 as a light source is reflected by a dichroic mirror potion 16 of an optical element 14 having characteristics of a dichroic mirror as well as a reflection mirror (hereinafter called an optical element 14).

The optical element 14 has a reflection mirror portion 18 in addition to the dichroic mirror portion 16. These dichroic mirror portion 16 and reflection mirror portion 18 are connected by a combining member 20. In other words, the optical element 14 is an optical component that the dichroic mirror portion 16 and the reflection mirror portion 18 are formed in a body through the combining member 20. This is the characteristic of the first embodiment.

As is evident from FIG. 1, the central portion of the combining member 20 where the optical path exists is hollow in order not to disturb the light transmitting through or reflected by the dichroic mirror portion 16 or the reflection mirror portion 18.

Further, the laser beam 12 reflected from the dichroic potion 16 of the optical element 14 is incident to a scanning unit 22, and is scanned two-dimensionally. Then, the laser beam 12 scanned by the scanning unit 22 is passed through the scanning optical system 24 consisting of a plurality of lenses and the like, and is incident to the objective lens 26. A specimen 30 placed on a stage 28 is illuminated and scanned two-dimensionally by the laser beam 12 in the state of converged by the objective lens 26.

Fluorescence 32 with a specific wavelength is emitted, in accordance with a fluorescence reagent used depending on various purposes of observation, from the specimen 30 illuminated and scanned two-dimensionally by the converged laser beam 12. The fluorescence 32 emitted from the specimen 30 as a detecting light passes along the optical path where the laser beam 12 has passed in the opposite direction, and reaches the dichroic mirror portion 16 of the optical element 14 via the objective lens 26, the scanning optical system 24, and the scanning unit 22.

The fluorescence 32 with a specific wavelength reached the dichroic mirror portion 16 of the optical element 14 transmits the dichroic mirror portion 16 without being reflected due to the characteristic of the dichroic mirror, is incident to the reflection mirror portion 18 of the optical element 14, and is incident on a collector lens 34. Then, the fluorescence 32 is converged by the collector lens 34 and focuses on the aperture formed on the aperture plate 36 placed on the position optically conjugate with the focal plane of the objective lens 26.

Only the fluorescence 32 converged and focused on the aperture of the aperture plate 36 passes through the aperture and reaches a photoelectric detector 38. Then, light intensity data of the fluorescence 32 photoelectrically transformed by the photoelectric detector 38 is converted into digital signal by an A/D converter 40.

The digital signal from the A/D converter 40 is input into a CPU 42 with a sampling clock synchronized with the scanning of the scanning unit 22. By the CPU 42, two-dimensional image of the specimen 30 optically sliced on the focal plane of the objective lens 26 is formed, and is properly shown on a display (not shown).

Then, light paths of the laser beam 12 and the fluorescence 32 in the case when the optical element 14 of the confocal fluorescence microscope shown in FIG. 1 is replaced will be explained with reference to FIGS. 2A and 2B.

In order to clarify the drawing, the combining member 20 of the optical element 14 is drawn only the outline, and the numerical value of the angle incident to or exit from the dichroic mirror portion 16 or the reflection mirror portion 18 is written on its complimentary angle portion.

As shown in FIG. 2A, the dichroic mirror portion 16 and the reflection mirror portion 18 of the optical element 14 are combined to the combining member 20 such that the reflection surface of the dichroic mirror portion 16 relative to the laser beam 12 and that of the reflection mirror portion 18 relative to the fluorescence 32 become parallel. Moreover, the optical element 14 is set such that the reflection surface of the dichroic mirror portion 16 is at 45° relative to the laser beam 12 for excitation emitted from the laser unit 10.

Accordingly, the laser beam 12 for excitation emitted from the laser unit 10 is incident to the dichroic mirror portion 16 of the optical element 14 at an incident angle of 45° and is reflected thereby at an exit angle of 45°. Then, as stated above, after scanning the specimen 30 two-dimensionally, the fluorescence 32 emitted from the specimen 30 as a detecting light passes along the optical path where the laser beam 12 has passed in the opposite direction, and returns to the dichroic mirror portion 16 of the optical element 14.

Furthermore, the fluorescence 32 as a detecting light returned to the dichroic mirror portion 16 of the optical element 14 is incident to the dichroic mirror portion 16 at an angle of 45° which is the same as the exit angle of the laser beam 12 in accordance with the principle of the confocal microscope. Then, the fluorescense 32 passes through the dichroic mirror portion 16, and goes toward the reflection mirror portion 18. The fluorescence 32 incident to the reflection mirror portion 18 at an angle of 45° is reflected thereby at an exit angle of 45° and goes toward the collector lens 34. The fluorescence 32 going toward the collector lens 34 is converged by the collector lens 34 to focus on the aperture formed on the aperture plate 36 placed on the position optically conjugate with the focal plane of the objective lens 26.

When the wavelength of the fluorescence 32 (detecting wavelength of the fluorescence) emitted from the specimen 30 is changed depending on the purpose of observation of the specimen 30 by changing the fluorescence reagent applied to the specimen 30, it becomes necessary for the optical element 14 having been used to be replaced by an optical element 14 equipped with a dichroic mirror portion 16 having a required dichroic characteristic in accordance with the new detecting wavelength of the fluorescence.

On changing the optical element 14, it is assumed that the posture of the optical element 14 is deviated by an angle of δ as shown in FIG. 2B. In other words, it is assumed that the dichroic mirror portion 16 and the reflection mirror portion 18 of the optical element 14 are shifted in a body by an angle of δ in comparison with the case shown in FIG. 2A because of the replacement of the optical elements 14.

In this case, the laser beam 12 for excitation emitted from the laser unit 10 is incident to the dichroic mirror portion 16 of the optical element 14 at an incident angle of (45°−δ), is reflected at an exit angle of (45°−δ), goes to the scanning unit 22, and scans the specimen 30 two-dimensionally via the objective lens 26 and others. The direction of the laser beam 12 varies by the angle of 2δ relative to the case shown in FIG. 2A. Then, the fluorescence 32 emitted from the specimen 30 as a detecting light passes along the optical path where the laser beam 12 has passed in the opposite direction, and returns to the dichroic mirror portion 16 of the optical element 14.

However, the fluorescence 32 as a detecting light returned to the dichroic mirror portion 16 of the optical element 14 in accordance with the principle of the confocal microscope is different from the case shown in FIG. 2A by an angle of 2δ, since the reflection surface itself of the dichroic portion 16 shifts by the angle of δ, the fluorescence 32 is incident to the dichroic mirror portion 16 at an angle of (45°−δ) which is the same as the exit angle of (45°−δ). Then, the fluorescence 32 goes toward the reflection mirror portion 18 passing through the dichroic mirror portion 16.

In the reflection mirror portion 18, the fluorescence 32 incident thereon at the angle of (45°−δ) is reflected thereby at the angle of (45°−δ), and goes toward the collector lens 34. Since the reflection surface of the reflection mirror portion 18 also differs from the case shown in FIG. 2A by the angle of δ, the direction of the fluorescence 32 going toward the collector lens 34 becomes the same direction as shown in FIG. 2A. Accordingly, the fluorescence 32 going toward the collector lens 34 is converged by the collector lens 34 to the same converging point as shown in FIG. 2A.

As described above, when the optical element 14 is used, the fluorescence 32 from the specimen 30 is always converged to the same point even if some difference of setting position and of posture have been introduced while changing.

Although the explanation described above is limited to the case that the dichroic mirror portion 16 and the reflection mirror portion 18 of the optical element 14 are connected to the combining member 20 such that the reflection surface of the dichroic mirror portion 16 reflecting the laser beam 12 and that of the reflection mirror portion 18 reflecting the fluorescence 32 become parallel, and to the case that the reflection surface of the dichroic mirror portion 16 is set to make an angle of 45° relative to the laser beam 12 for excitation emitted from the laser unit 10, the invention is not limited to the explanation.

For example, reflection surfaces of the dichroic mirror portion 16 and the reflection mirror portion 18 of the optical element 14 may not be parallel, and the reflection surface of the dichroic mirror portion 16 may not be set to make an angle of 45° relative to the laser beam 12 for excitation emitted from the laser unit 10. As understood easily by drawing a figure of the optical paths of the laser beam 12 and the fluorescence 32 regarding the optical element 14, the explanation using FIGS. 2A and 2B can be applied to the case not limited to these conditions.

As described above, the confocal fluorescence microscope according to the present embodiment makes it possible to achieve the effect described below by using the optical element 14 constructed such that the dichroic mirror portion 16 and the reflection mirror portion 18 are combined by the combining member 20 in a body instead of using a conventional unit beam splitter and a conventional unit reflection mirror. On changing the wavelength of the laser beam 12 for excitation illuminating the specimen 30 and that of the fluorescence 32 as a detecting light emitted from the specimen 30, even if some error in angle of the reflection surface of the dichroic mirror portion 16 is introduced by the poor positional repeatability of the optical element 14, the angle of the reflection surface of the reflection mirror portion 18 varies together with that of the dichroic mirror portion 16, so that the converging point of the fluorescence 32 is always kept in the same position after transmitting through the dichroic mirror portion 16, being reflected by the reflection mirror portion 18, and being converged by the collector lens 34. Accordingly, the fluorescence 32 from the specimen 30 passes through the aperture of the aperture plate 36, reaches the photoelectric detector 38 without loss, and generates a clear two-dimensional image of the specimen 30.

Moreover, even if the positional repeatability is somewhat poor on changing the optical element 14, the function of the confocal fluorescence microscope can be sufficiently kept, so that it is not necessary to pay close attention to keeping the angle of the reflection surface of the dichroic mirror portion 16 of the optical element 14, and not necessary to adjust precisely after changing. Therefore, it becomes great advantage for the general user of the confocal fluorescence microscope to be able to change the optical element 14 extremely easily and simply.

Furthermore, the optical element 14 can be easily produced by using a conventional unit beam splitter and a conventional unit reflection mirror, so that it can be realized with simple construction and with cheep manufacturing cost.

<Second Embodiment>

The whole construction of a confocal fluorescence microscope according to a second embodiment is almost the same as the aforementioned confocal fluorescence microscope according to the first embodiment shown in FIG. 1. The second embodiment is characterized in that instead of the optical element 14 used in the first embodiment, another element having similar characteristics is used in this embodiment.

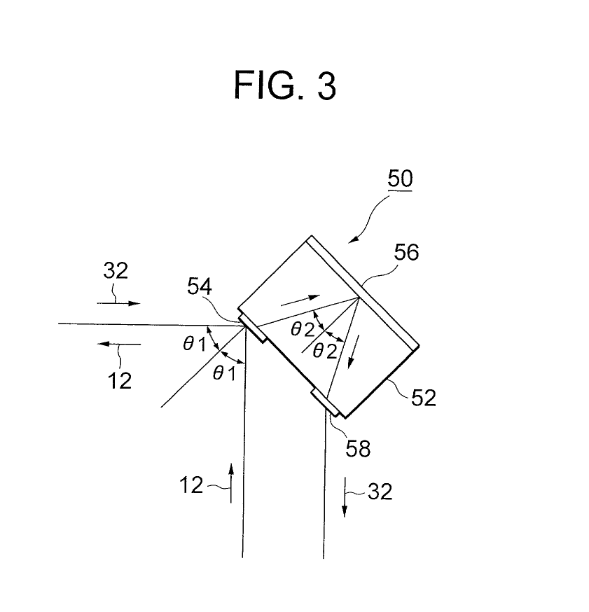

FIG. 3 is a diagram showing the sectional view of an optical element having characteristics of a dichroic mirror as well as a reflection mirror of the confocal fluorescence microscope according to the second embodiment. By the way, the same reference symbol is attached to the same element in the confocal fluorescence microscope according to the first embodiment shown in FIG. 1, and the repeated explanation will be abbreviated.

As shown in FIG. 3, the optical element 50, used in the confocal fluorescence microscope according to the second embodiment, having characteristics of a dichroic mirror together with a reflection mirror is surrounded with a plurality of planes including a first plane and a second plane being parallel with each other. The optical element 50 is composed of a transparent optical material 52 made of optical glass or optical resin having a square sectional shape. A film 54 having characteristics of a dichroic mirror (hereinafter simply called “a dichroic mirror film 54”) is formed on a predetermined area of the first plane where the fluorescence 32 from the specimen 30 or the laser beam 12 from the laser unit 10 is incident. A film 56 having characteristics of total reflection mirror (hereinafter simply called “a total reflection film 56”) is formed on the whole area of the second plane where the fluorescence 32 transmitted through the dichroic mirror film 54 reaches through the transparent optical material 52. A film 58 having anti-reflection characteristics (hereinafter simply called “an anti-reflection film 58”) is formed on a predetermined area of the first plane where the fluorescence 32 totally reflected by the total reflection film 56 goes out through the transparent optical material 52. The anti-reflection film 58 has a purpose to reduce the attenuation of the fluorescence 32 through the optical element 50 as much as possible for generating a clear two-dimensional image of the specimen 30.

Then, the optical paths of the laser beam 12 and the fluorescence 32 regarding the optical element 50 is explained.

The laser beam 12 for excitation emitted from the laser unit 10 is incident to the dichroic mirror film 54 formed on the first plane of the optical element 50 at a predetermined angle θ1 as shown in FIG. 3, is reflected at an exit angle of θ1, and goes toward the scanning unit 22.

The laser beam 12 going toward the scanning unit 22 scans the specimen 30 two-dimensionally as same as the aforementioned case of the first embodiment. The fluorescence 32 as a detecting light emitted from the specimen 30 passes along the optical path where the laser beam 12 has passed in the opposite direction, and returns to the dichroic mirror film 54 on the first plane of the optical element 50.

The fluorescence 32 returned to the dichroic mirror film 54 is incident to the dichroic mirror film 54 at an angle of θ1 which is the same as the exit angle θ1 of the laser beam 12 in accordance with the principle of the confocal microscope, passes through the dichroic mirror film 54 and the transparent optical material 52, and goes toward the total reflection film 56 on the second plane parallel to the first plane where the dichroic mirror film 54 is formed. The fluorescence 32 incident to the reflection film 56 at an incident angle of θ2 is reflected at an exit angle of θ2, goes toward the anti-reflection film 58 on the first plane, goes out from the transparent optical material 52 through the anti-reflection film 58, and goes toward the collector lens 34.

The fluorescence 32 going toward the collector lens 34 is converged by the collector lens 34 to focus on the aperture formed on the aperture plate 36 placed on the position optically conjugate with the focal plane of the objective lens 26.

When the wavelength of the fluorescence 32 (detecting wavelength of the fluorescence) emitted from the specimen 30 is changed depending on the purpose of observation of the specimen 30 by changing the fluorescence reagent applied to the specimen 30, it becomes necessary for the optical element 50 having been used to be changed with an optical element 50 equipped with a dichroic mirror film 54 having a required dichroic characteristic in accordance with the new detecting wavelength of the fluorescence. It is assumed that, on changing the optical element 50, the posture of the optical element 50 is changed by an angle of δ. In other words, it is assumed that the reflection surfaces of the dichroic mirror film 54 and the total reflection film 56 are changed in a body by an angle of δ.

In this second embodiment also, because of the same reason as described in the first embodiment, the fluorescence 32 from the specimen 30 is converged by the collector lens 34 to the same converging point as before changing.

As same as the case that the dichroic mirror portion 16 and the reflection mirror portion 18 of the optical element 14 according to the first embodiment are explained, the first plane forming the dichroic mirror film 54 and the second plane forming the total reflection film 56 in the optical element 50 of the second embodiment may be non-parallel with each other. Accordingly, the sectional shape of the clear optical material 52 is not limited to a square, and the clear optical material 52 may be a prism surrounded by planes not parallel with each other.

Moreover, although the fluorescence 32 reflected from the total reflection film 56 of the second plane of the optical element 50 goes out from the transparent optical material 52 through the first plane, the plane where the fluorescence goes out is not limited to the first plane. It may be a third plane other than the first plane and the second plane. In this case, the anti-reflection film 58 is formed on the third plane, not on the first plane where the dichroic mirror film 54 is formed.

As described above, when the wavelength of the fluorescence 32 emitted from the specimen 30 is changed depending on the purpose of observation of the specimen 30 by changing the fluorescence reagent applied to the specimen 30, the confocal fluorescence microscope according to the present embodiment makes it possible to obtain the same performance as described in the first embodiment by changing the optical element 50.

On changing the optical element 50, even if some error in angle or position of the optical element 50 is introduced by-the poor positional repeatability, the converging point of the fluorescence 32 from the specimen 30 is always kept in the same position. Accordingly, the fluorescence 32 from the specimen 30 passes through the aperture of the aperture plate 36, reaches the photoelectric detector 38 without loss, and generates a clear two-dimensional image of the specimen 30. Moreover, on changing the optical element 50, it is not necessary to pay close attention to keeping the angle of the reflection surface of the dichroic mirror film 54 of the optical element 50, and not necessary to adjust precisely after changing. Therefore, it becomes great advantage for the general user of the confocal fluorescence microscope to be able to change the optical element 50 extremely easily and simply.

Furthermore, the optical element 50 can be smaller than the combination of a conventional unit beam splitter and a conventional unit reflection mirror, so that it has another advantage to contribute for making the confocal fluorescence microscope to be compact.

<Third Embodiment>

The whole construction of a confocal fluorescence microscope according to a third embodiment is almost the same as the aforementioned confocal fluorescence microscope according to the second embodiment. The third embodiment is characterized in that some improvement is added to the optical element 50 used in the second embodiment.

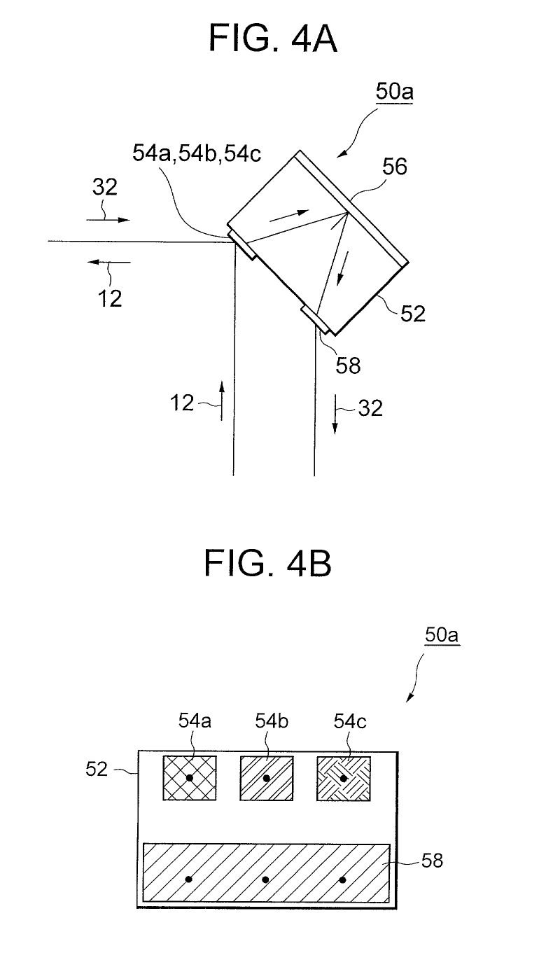

FIGS. 4A and 4B are diagrams showing the sectional view and the front elevation view, respectively, of an optical element having characteristics of a dichroic mirror as well as a reflection mirror of a confocal fluorescence microscope according to the third embodiment of the present invention. By the way, the same reference symbol is attached to the same element in the confocal fluorescence microscope according to the first and second embodiments shown in FIGS. 1 and 3, and the repeated explanation will be abbreviated.

As shown in FIGS. 4A and 4B, an optical element 50a, used in the confocal fluorescence microscope according to the third embodiment, having characteristics of the dichroic mirror as well as the reflection mirror has basically the same construction as the optical element 50 in the above-mentioned second embodiment. The optical element 50a is characterized in that the dichroic mirror film 54 is divided into dichroic mirror films 54a, 54b, and 54c having different dichroic mirror characteristics with each other. The third embodiment is also characterized in that a slider (not shown) for sliding the optical element 50a is set.

By the way, the optical paths of the laser beam 12 and the fluorescence 32 regarding the optical element 50a is the same as explained in the second embodiment, and repeated explanation is abbreviated.

When the wavelength of the fluorescence 32 (detecting wavelength of the fluorescence) emitted from the specimen 30 is changed depending on the purpose of observation of the specimen 30 by changing the fluorescence reagent applied to the specimen 30, instead of changing the optical element 50 as in the case of the second embodiment, the optical element 50a is slid by the slider so as to control such that the fluorescence 32 from the specimen 30 is led from the dichroic mirror film 54a used previously to the dichroic mirror film 54b having required dichroic mirror characteristics for new detecting wavelength of the fluorescence. The control may be carried out manually, or automatically, for example, by using an input device for inputting the kind of the light source and a sliding mechanism for sliding the optical element 50a in response to the information of the light source input by the input device.

As same as the case described regarding the dichroic mirror film 54, the total reflection film 56 and the anti-reflection film 58 of the optical element 50 according to the second embodiment, the first plane where the dichroic mirror film 54a, 54b, and 54c are formed and the second plane where the reflection film 56 is formed may be non-parallel with each other. Accordingly, the sectional shape of the transparent optical material 52 is not limited to a square, and the transparent optical material 52 may be a prism surrounded by planes not parallel with each other. Moreover, the plane where the fluorescence 32 goes out is not limited to the first plane. It may be a third plane. In this case, the anti-reflection film 58 is formed on the third plane.

Furthermore, in this case, although the dichroic mirror films 54a, 54b, and 54c having different dichroic mirror characteristics with each other are formed separately on the first plane of the clear optical element 52, the number of the kinds of the dichroic mirror films is not limited to three, and, as a matter of course, the number can be increased as the need arises.

As described above, in the confocal fluorescence microscope according to the present embodiment, when the wavelength of the fluorescence 32 emitted from the specimen 30 is changed depending on the purpose of observation of the specimen 30 by changing the fluorescence reagent applied to the specimen 30, the optical element 50a is slid by the slider (not shown) so as to control such that the fluorescence 32 from the specimen 30 is led from the dichroic mirror film 54a used previously to the dichroic mirror film 54b having required dichroic mirror characteristics for the new detecting wavelength of the fluorescence. This control makes it unnecessary to change the optical element 50a. Moreover, since it is not necessary to be worried about the mechanical play or the precision in the motion while sliding, the operability of the confocal fluorescence microscope may be greatly improved.

In other words, on changing the wavelength of the fluorescence 32 as a detecting light emitted from the specimen 30 depending on the purpose of observation of the specimen 30, the converging point of the fluorescence 32 converged by the collector lens 34 is always kept at the same point by sliding the optical element 50a using the slider even if the wavelength of the fluorescence 32 is new. Therefore, the fluorescence 32 from the specimen 30 passes through the aperture of the aperture plate 36, reaches the photoelectric detector 38 without loss, and generates a clear two-dimensional image of the specimen 30.

As described above, a confocal microscope according to the present invention can be obtained the effect described below.

In the aforementioned embodiments, although only a few examples of the confocal fluorescence microscope are exemplified, the present invention is not limited to the confocal fluorescence microscope. By replacing the dichroic mirror according to each embodiment to a beam splitter suitable for an observation other than the fluorescence observation, it becomes possible for the confocal fluorescence microscope according to the present invention to be used for the observation other than the fluorescence observation.

In each embodiment of the present invention, since a confocal fluorescence microscope is exemplified, the observation light is fluorescence emitted from the fluorescence reagent applied to the specimen. When the observation is not the fluorescence observation, the observation light is a reflection light from the specimen illuminated by an illumination light.

In the confocal microscope according to the present invention, instead of a conventional unit beam splitter and a conventional unit reflection mirror, an optical element, composed of a beam splitter and a reflection mirror combined with each other in a body, having characteristics of the beam splitter as well as the reflection mirror is used. Accordingly, on mounting the beam splitter and the reflection mirror for a replacement purpose, it is not necessary to adjust positional relation between the beam splitter and the reflection mirror, so that both of the beam splitter and the reflection mirror can be mounted easily.

Additional advantages and modification will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalents.

What is claimed is:

1. A confocal microscope comprising;
a light source;
an objective lens;
a scanning unit for scanning a laser beam emitted from the light source, and for illuminating a specimen via the objective lens;
a beam splitter for reflecting the laser beam emitted from the light source going toward the objective lens, and for transmitting a detecting light reflected from the specimen;
a reflection mirror for reflecting the detecting light transmitted through the beam splitter;
an optical element on which the beam splitter and the reflection mirror are attached;
a collector lens for converging the detecting light reflected by the reflection mirror;
an aperture set in a position optically conjugate with the focal plane of the objective lens; and
a detector for detecting the detecting light converged by the collector lens and passed through the aperture.

2. The confocal microscope according to claim 1, wherein the optical element is removably attached.

3. The confocal microscope according to claim wherein the optical element is made of a transparent optical material defined by a plurality of planes;
wherein a plane on which the laser beam from the light source and the detecting light from the specimen are incident has characteristics of a beam splitter; and
wherein a plane on which the detecting light from the specimen entered into the optical element reaches has characteristics of a reflection mirror.

4. The confocal microscope according to claim 3;
wherein the plane on which the laser beam from the light source and the detecting light from the specimen are incident is divided into a plurality of areas each having different beam splitter characteristics; and
wherein the optical element is slidable such that the laser beam from the light source and the detecting light from the specimen are incident to a predetermined area among the plurality of areas.

5. The confocal microscope according to claim 3 or 4;
wherein a plane on which the detecting light from the specimen entered into the optical element goes out has characteristics of an anti-reflection film.

6. The confocal microscope according to claim 1, wherein the beam splitter is a dichroic mirror.
